(19) United States
(12) Patent Application Publication
(10) Pub. No.: US 2017/0031347 A1
(43) Pub. Date: Feb. 2, 2017

(54) METHOD AND SYSTEM FOR THROUGHPUT DETERMINATION OF A SEMICONDUCTOR MANUFACTURING TOOL

(71) Applicant: SAMSUNG ELECTRONICS CO., LTD., SUWON-SI (KR)

(72) Inventors: RAJESH-SATISH CHAUKWALE, MARATHAHALLI POST (IN); RATHISH BALAGANGADHAR, KAGADASSAPURA (IN); VISHAL-RAJENDRA GUJALWAR, MARATHAHALLI POST (IN); HYUN-JIN LEE, INCHEON (KR)

(21) Appl. No.: 15/165,634

(22) Filed: May 26, 2016

(30) Foreign Application Priority Data
Jul. 31, 2015 (IN) 3980/CHE/2015

(51) Int. Cl. G05B 19/4063; G05B 15/02

(52) U.S. Cl. CPC G05B 19/4063; G05B 15/02; G05B 2219/32267

(57) ABSTRACT

A method for measuring throughput of a semiconductor manufacturing tool includes receiving a layout of the semiconductor manufacturing tool as an input, calculating a full capacity number (FCN) based on a number of wafer-receiving slots disposed in at least one component of the semiconductor manufacturing tool, determining a number of wafers to be processed by the semiconductor manufacturing tool based on the FCN, determining a path for the wafers to enter stages of the semiconductor manufacturing tool based on at least one parameter, determining a time for one of the wafers to enter at least one of the wafer-receiving slots based on a feedback value, and determining a process completion time based on the determined time for the one of the wafers to enter the at least one of the wafer-receiving slots.

### CROSS-REFERENCE TO RELATED APPLICATIONS

This application claims priority under 35 U.S.C. §119 to Indian Patent Application No. 3980/CHE/2015 filed on Jul. 31, 2015, the disclosure of which is hereby incorporated by reference in its entirety.

### TECHNICAL FIELD

Exemplary embodiments of the inventive concept relate to a semiconductor manufacturing tool, and more particularly, to predicting the throughput of a semiconductor manufacturing tool.

### DISCUSSION OF THE RELATED ART

The semiconductor manufacturing industry uses a number of tools at various stages of semiconductor production. Efficiency and throughput of a production unit increases as the efficiency of semiconductor manufacturing tools increases. Efficiency may be defined in terms of various parameters such as, for example, the speed of the semiconductor manufacturing tools (e.g., the number of semiconductor wafers output by a semiconductor manufacturing tool in a given time period) and the quality of the outputted semiconductor wafers.

Manufacturers of semiconductor manufacturing tools are engaged in continuous research to develop semiconductor manufacturing tools having improved efficiency. Traditional methods involve developing semiconductor manufacturing tools, testing their efficiency, and making necessary modifications to the tools if necessary. However, this approach may not be feasible, since the manufacturing tool itself may be very large and/or complicated, and may be frequently modified.

Another approach involves determining the throughput of a semiconductor manufacturing tool using throughput models. In this approach, the throughput of a semiconductor manufacturing tool is determined for a desired manufacturing scenario based on throughput models that are generated by a system. The generated throughput may be used by a user/designer to assess performance of the semiconductor manufacturing tool and make changes if necessary.

### SUMMARY

Exemplary embodiments of the inventive concept provide a system and method that allow for the throughput of a semiconductor manufacturing tool to be measured based on a layout of the semiconductor manufacturing tool inputted, for example, by a user.

According to an exemplary embodiment of the inventive concept, a method for measuring a throughput of a semiconductor manufacturing tool includes receiving a layout of the semiconductor manufacturing tool as an input, calculating a full capacity number (FCN) based on a number of a plurality of wafer-receiving slots disposed in at least one component of the semiconductor manufacturing tool, determining a number of a plurality of wafers to be processed by the semiconductor manufacturing tool based on the FCN, determining a path for the wafers to enter stages of the semiconductor manufacturing tool based on at least one parameter, and determining a time for one of the wafers to enter at least one of the wafer-receiving slots based on a feedback value. The feedback value represents a time at which the at least one wafer-receiving slot is available to receive the one of the wafers. The method further includes determining a process completion time based on the determined time for the one of the wafers to enter the at least one of the wafer-receiving slots. The process completion time indicates a total time taken by the semiconductor manufacturing tool to process and output the plurality of wafers.

According to an exemplary embodiment of the inventive concept, a system for measuring a throughput of a semiconductor manufacturing tool includes a memory storing a computer program, and a processor configured to execute the computer program. The computer program is configured to receive a layout of the semiconductor manufacturing tool as an input, calculate a full capacity number (FCN) based on a number of a plurality of wafer-receiving slots disposed in at least one component of the semiconductor manufacturing tool, determine a number of a plurality of wafers to be processed by the semiconductor manufacturing tool based on the FCN, determine a path for the wafers to enter stages of the semiconductor manufacturing tool based on at least one parameter, and determine a time for one of the wafers to enter at least one of the wafer-receiving slots based on a feedback value. The feedback value represents a time at which the at least one wafer-receiving slot is available to receive the one of the wafers. The computer program is further configured to determine a process completion time based on the determined time for the one of the wafers to enter the at least one of the wafer-receiving slots. The process completion time indicates a total time taken by the semiconductor manufacturing tool to process and output the plurality of wafers.

According to an exemplary embodiment of the inventive concept, a computer program product for measuring a throughput of a semiconductor manufacturing tool is provided. The computer program product includes a computer readable storage medium having program instructions embodied therewith, the program instructions executable by a processor to cause the processor to receive a layout of the semiconductor manufacturing tool as an input, calculate a full capacity number (FCN) based on a number of a plurality of wafer-receiving slots disposed in at least one component of the semiconductor manufacturing tool, determine a number of a plurality of wafers to be processed by the semiconductor manufacturing tool based on the FCN, determine a path for the wafers to enter stages of the semiconductor manufacturing tool based on at least one parameter, and determine a time for one of the wafers to enter at least one of the wafer-receiving slots based on a feedback value. The feedback value represents a time at which the at least one wafer-receiving slot is available to receive the one of the wafers. The computer program is further configured to determine a process completion time based on the determined time for the one of the wafers to enter the at least one of the wafer-receiving slots. The process completion time indicates a total time taken by the semiconductor manufacturing tool to process and output the plurality of wafers.

### BRIEF DESCRIPTION OF THE DRAWINGS

The above and other features of the present inventive concept will become more apparent by describing in detail exemplary embodiments thereof with reference to the accompanying drawings, in which:

FIG. 1 illustrates a block diagram of a throughput determination module, according to an exemplary embodiment of the inventive concept.

FIG. 2 illustrates a block diagram that shows components of a throughput determination module, according to an exemplary embodiment of the inventive concept.

FIG. 3 is a flow diagram that depicts operations performed in the process of determining throughput of a semiconductor manufacturing tool, according to exemplary embodiments of the inventive concept.

FIG. 4 depicts an example input layout for which throughput is determined using the throughput determination module, according to exemplary embodiments of the inventive concept.

### DETAILED DESCRIPTION

Exemplary embodiments of the present inventive concept will be described more fully hereinafter with reference to the accompanying drawings. In the drawings, the size and relative sizes of layers and regions may be exaggerated for clarity. Like reference numerals may refer to like elements throughout the accompanying drawings.

Exemplary embodiments of the inventive concept provide a throughput measurement system. The throughput measurement system disclosed herein may be used to measure and predict the throughput of a semiconductor chip manufacturing tool, and any such tool that can be modeled based on their components and corresponding behaviors.

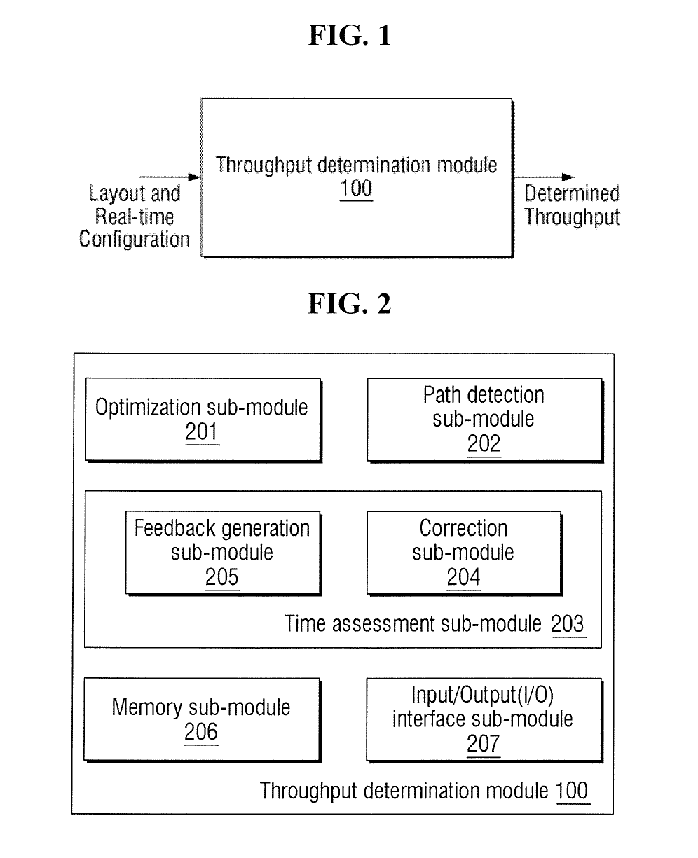

FIG. 1 illustrates a block diagram of a throughput determination module, according to exemplary embodiments of the inventive concept. The throughput determination module 100 may be configured to receive, using a suitable input module of the throughput determination module 100, at least one real-time design and configuration (e.g., a layout) of a semiconductor manufacturing tool (also referred to herein as a SEMI cluster tool, a semiconductor manufacturing tool, or generally as a tool) as input. The throughput determination module 100 measures the throughput of the tool via the layout. In an exemplary embodiment, the input is a layout of the tool. The layout indicates, for example, the number of components at each stage of the tool, and the connections between the components. The input may further include a value of at least one parameter associated with at least one component depicted in the layout. For example, the input can be the name and/or type of a component that is intended to be present in the tool as indicated by the layout. The throughput determination module 100 can be further configured to include information relating to the capability of each component, for example, in terms of at least one performance parameter that defines the performance speed of the component. The throughput determination module 100 can be further configured to determine the throughput of the tool represented by the layout based on real-time configuration received as input. In an exemplary embodiment, the throughput of a tool represents the time taken by the tool to process all inputs (e.g., to process and output all semiconductor wafers input to the tool). The throughput determination module 100 can further be configured to provide at least one option for the user to specify and change components that constitute the tool as represented by the layout, for example, either before inputting the layout or in real-time. As a result, a change in throughput of the tool as a result of the tool including different components may be determined.

FIG. 2 illustrates a block diagram that shows components of a throughput determination module, according to exemplary embodiments of the inventive concept. The throughput determination module 100 includes, for example, an optimization sub-module 201, a path detection sub-module 202, a time assessment sub-module 203, a memory sub-module 206, and an Input/Output (I/O) interface sub-module 207. The time assessment sub-module 203 includes, for example, a correction sub-module 204 and a feedback generation sub-module 205.

The optimization sub-module 201 may be configured to determine an optimum number of wafers that can be processed in one iteration. For example, in a semiconductor manufacturing tool, wafers to be processed enter a processing chamber (also referred to as a processing module) from a load lock. If the number of slots (also referred to as wafer-receiving slots) in the processing chamber is less than the number of slots in the load lock, wafers that are in the load lock may have to wait for some time to enter the processing chamber, which in turn causes a delay. In order to avoid or minimize this wait time, the optimization sub-module 201 determines the optimum number of wafers such that wafers in the load lock can enter the processing chamber with a minimum waiting period. In an exemplary embodiment, the optimization sub-module 201 determines the optimum number of wafers based on a Full Capacity Number (FCN). The FCN may be calculated based on a number of slots (e.g., the minimum number of slots) disposed in components of the semiconductor manufacturing tool. For example, according to exemplary embodiments, the FCN may be calculated using the following equation:

Full Capacity Number (FCN)=Min (Slots in load lock, Slots in processing chamber)

The path detection sub-module 202 may be configured to determine a path that can be used by the wafer to be moved to next node. In an exemplary embodiment in which only one path is available between a source node (e.g., a node/location at which the wafer is cunently placed) and a destination node (e.g., a node/location at which the wafer is to be moved), that one path is used by default. In exemplary embodiments in which more than one path is present between the source and destination nodes, the path detection sub-module 202 selects at least one path from among the available paths based on heuristics. According to exemplary embodiments, herein, the term heuristics refers to a determination made based on a combination of at least one of the following parameters:

1) Transfer time: Indicates the transfer time for a path. For example, in a semiconductor manufacturing tool, the transfer time may vary for different components in the tool such as, for example, processing chambers, robots, load locks, coolers, load ports, etc.

2) Processing time: Indicates the processing time that is specific to various processing chambers in the semiconductor tool. This may vary based on factors such as, for example, the aging of processing chambers.

3) Shortest path to destination: Indicates the shortest path to reach the destination.

4) Waiting Time: Represents the time taken for a processing chamber to be ready to accept a wafer after undergoing pre-processing. This in turn indicates the time that the wafer may have to wait to enter the processing chamber.

When the parameters listed above are used for determining the heuristics value, the value can be determined as, for example:

Heuristics Value=(shortest path)alpha*(transfer time)beta*(waiting time)gamma*(processing time)delta

In the above equation, alpha is a weightage factor for the shortest path, beta is a weightage factor for the transfer time, gamma is a weightage factor for the waiting time, and delta is a weightage factor for the processing time.

The time assessment sub-module 203 may be configured to determine the time it takes for a wafer to enter a slot. In an exemplary embodiment, the time assessment sub-module 203 determines the time it takes for the wafer to enter the slot based on a nodeTime, which is collected from the feedback generation sub-module 205. The nodeTime for a particular slot/node represents the time period during which the node/slot is available for processing. The time assessment sub-module 203 may be further configured to determine the throughput of the tool in terms of time. In this process, the time assessment sub-module 203 may consider factors such as, for example, the layout of the tool, the paths between components of the tool as indicated by the layout, nodeTime(s), and the capacity of the processing module(s) (also referred to herein as processing chamber(s)). In an exemplary embodiment, the time assessment sub-module 203 collects correction data and feedback time from the correction sub-module 204 and the feedback generation sub-module 205, respectively, and uses the correction data and the feedback time information to determine the time it takes for the wafer to enter the slot.

The correction sub-module 204 may be configured to check to determine whether any correction is required in terms of, for example, the path selected for a wafer, and make necessary corrections to the path. For example, while determining a path for the wafer, the current states of components are considered. In some scenarios, it is possible that the state of at least one component is changed by another wafer after determining the path. In this case, path correction is required, as a current wafer cannot proceed on the path that was previously determined.

The feedback generation sub-module 205 may be configured to identify a nodeTime corresponding to a node being considered, and provide the nodeTime as a feedback time that represents the time at which the node being considered is available, to the time assessment sub-module 203. In an exemplary embodiment, the time assessment sub-module 203 may be configured to collect details relating to a path being considered by the path detection sub-module 202, identify nodes in the path, and collect the corresponding nodeTime(s).

The memory sub-module 206 may be configured to store all data required to execute the throughput determination process. In an exemplary embodiment, the memory sub-module 206 may store static information that is pre-configured by an authorized user. For example, performance parameters of various components may be stored as static information. In an exemplary embodiment, the memory sub-module 206 may dynamically receive and store information for further processing in addition to or instead of the static information. For example, configuration data as well as layouts may be received and stored as dynamic inputs. The memory sub-module 206 may be configured to support actions such as, for example, editing, formatting, and deletion of data stored in the memory sub-module 206.

The I/O interface sub-module 207 may be configured to provide at least one option for a user to provide at least one input to the throughput determination module 100. The I/O interface sub-module 207 may be further configured to provide output of the throughput determination module 100 to the user, in at least one suitable format, as pre-configured by a user. In an exemplary embodiment, the output of the throughput determination module 100 may be provided to equipment that manufactures semiconductor manufacturing tools. Thus, once the throughput determination module 100 measures the throughput of a candidate tool (e.g., based on the inputted layout), and the measured throughput is determined to be acceptable, the output of the throughput determination module 100 may be provided (e.g., directly provided) to the equipment to facilitate the creation of a semiconductor manufacturing tool corresponding to the layout.

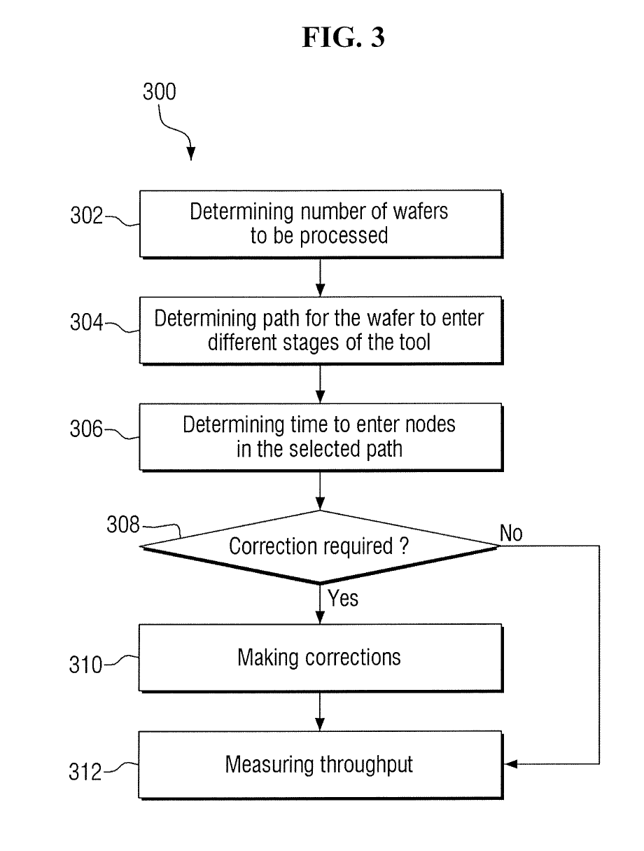

FIG. 3 is a flow diagram that depicts operations performed in the process of determining throughput of a tool, using the throughput determination module 100, according to exemplary embodiments of the inventive concept. To determine throughput of a tool, a layout of the tool is provided as input to the throughput determination module 100. Upon receiving the layout, the throughput determination module 100 parses and analyzes the input to identify the structure of the tool. The structure of the tool refers to information such as, for example, components of the tool, various stages of the tool, the number of slots at each stage, connections between different stages, different slots, different processing modules, etc.

The throughput determination module 100 further collects information relating to the number of wafers to be processed. For example, the optimization sub-module 201 of the throughput determination module 100 generates the FCN value based on the layout, and determines the number of wafers that the tool can process at a time (302) based on the FCN value. That is, once the layout of the semiconductor manufacturing tool has been received as an input, and once the FCN has been calculated, the number of wafers to be processed by the semiconductor manufacturing tool is determined (302) based on the FCN. As described above, the FCN may be calculated, for example, based on a number of slots (also referred to as wafer-receiving slots) disposed in components of the semiconductor manufacturing tool (e.g., as provided by the inputted layout).

A path for the wafer to enter different stages of the tool is determined by the path detection sub-module 202 (304). In an exemplary embodiment, in a scenario in which more than one path is available between a source and destination, the path is determined based on a heuristics value generated by the path detection sub-module 202, as described above. For example, the path for wafers to enter stages (e.g., components) of the semiconductor manufacturing tool is based on at least two parameters including, for example, the shortest path to a destination, the transfer time between the components, the waiting time of at least one processing chamber in the semiconductor manufacturing tool, and the processing time of the at least one processing chamber.

The time at which the wafer may enter a node is determined by the time assessment sub-module 203 of the throughput determination module 100 (306) based on, for example, feedback representing a time that the node is available to receive the wafer. Once the time is determined, the wafer may be scheduled to enter the node at the determined time. In an exemplary embodiment, the scheduling may not be performed in a first iteration of the manufacturing in which all stages of the tool are assumed to be free. However, in successive iterations, the determination is performed, as the nodes may not be free all the time. In the throughput determination module 100, the time at which each wafer enters and leaves each node is marked as nodeTime. The nodeTimes marked by different wafers for different nodes may collectively indicate the time of availability of each node. The nodeTime entered by different wafers acts as a reference data for other nodes in the same and/or subsequent iterations.

The system checks to determine whether correction is required (308). Correction refers to any adjustment made for the pre-determined time schedule for entering at least one node in at least one stage of the tool. The system may be configured to determine whether correction is required by checking to determine whether the schedule may result in any deadlock due to, for example, a change in status of any node, after the schedule has been initially determined by the time assessment sub-module 203.

If any correction is determined to be required, the time assessment sub-module 203 makes the required correction (302). Making a correction may refer to, for example, adjusting the scheduled time by adding or subtracting any suitable offset value, such that the time as per the new schedule does not result in a deadlock condition.

The throughput of the tool is determined/measured by the time assessment sub-module 203 (312). In an exemplary embodiment, the throughput is measured in terms of the amount of time that the tool takes to process and output all of the inputted wafers (e.g., a process completion time). The process completion time is based on the amount of time determined for the wafers to enter the wafer-receiving slots in the tool. In an exemplary scenario, assume that there are 4 wafers in total, and that the tool can process only 2 wafers at a time. This means that two iterations are to be performed. In this scenario, the throughput determination module 100 determines the total amount of time that will be taken by the tool as indicated by the layout to process all 4 wafers. In exemplary embodiments, a user may change the configuration of the layout dynamically, and observe the change in throughput of the tool with the change in configuration. As a result, the configuration of the tool that provides a desired throughput may be identified. The measured throughput may then be provided to the user in a suitable format using, for example, the I/O interface 207.

The various actions described with reference to the method 300 may be performed in the order shown in FIG. 3 or in a different order than the order shown in FIG. 3. In addition, some or all of the actions may be performed simultaneously. Further, in exemplary embodiments, some actions shown in FIG. 3 may be omitted.

Use Case Scenario:

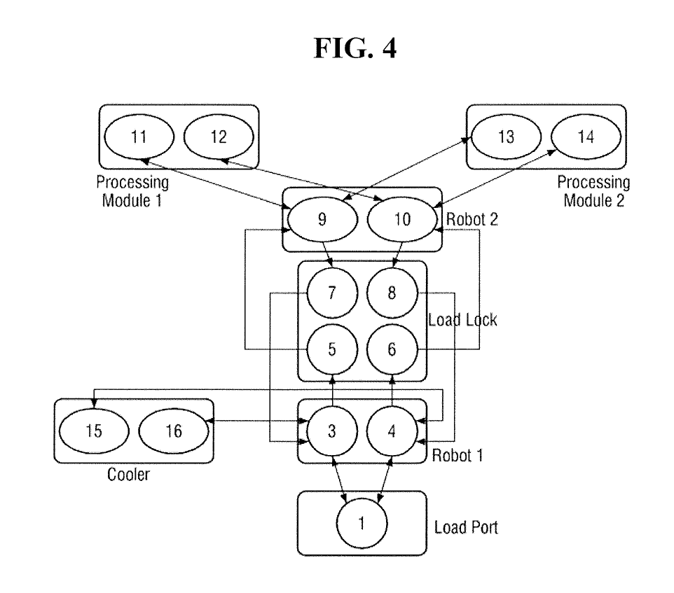

Consider the layout depicted in FIG. 4. In a use case scenario, assume:

i. The load port is the source and the destination of wafers

ii. All edge weights are 5 units (also referred to as time units) (e.g., milliseconds, seconds, minutes, etc.)

iii. Each processing module's processing time is 10 time units

iv. The load lock pump and vent time, also referred to the load lock to vacuum state (e.g., the amount of time that a wafer spends in the load lock before being ready to travel out of the load lock) is 10 time units

Further, assume that the recipe steps (e.g., the order of components that the wafers travel to) are:

i. Processing module 1 or Processing module 2

ii. Cooler

Assuming that the load port is the source and destination, the amount of time taken to process x wafers using the design and configuration of the given layout is described below. The components in the layout depicted in FIG. 4 include the load port, the load lock, robot 1, robot 2, processing module 1, processing module 2, and the cooler. These are the components used by the tool represented by the layout in FIG. 4 to process semiconductor wafers. Robot 1 transfers wafers between the load port, the load lock, and the cooler, and robot 2 transfers wafers between the load lock and processing modules 1 and 2. It is to be understood that the layout depicted in FIG. 4 is merely exemplary, and that exemplary embodiments of the present inventive concept may be applied to different layouts including various combinations of different types of components.

In the layout depicted in FIG. 4, slots (e.g., wafer slots disposed in the various components that receive wafers) are represented as nodes, and the edge weights of the edges between nodes represent transfer time.

For the given layout, the FCN is calculated as:

$$\begin{matrix}FCN = Min ( slots in load lock leading to processing modules , \\ slots in processing modules ) \\ = Min ( 4 , 2 ) \\ = 2\end{matrix}$$

As a result, the determination of the minimum of the above parameters results in the FCN being calculated as 2. Thus, in each iteration, 2 wafers may complete their wafer cycles.

The second iteration does not start until the first iteration completes. Further, wafers are created and start from the source component (e.g., the load port).

Iteration 1:

The first wafer (e.g., wafer1) is present in slot 1 of the load port. Upon detecting that there are 2 outgoing paths, the wafer 1 uses heuristics, as described above, to determine the optimal outgoing path. Since both paths have the same transfer time, no waiting time, the same shortest path, and no processing time, neither path is preferential to the other (e.g., both paths are optimal). Wafer1 selects node 3 as its next target node and travels to node 3. Similarly, wafer1 travels to node 5 of the load lock at time 10 units. While wafer1 leaves node 3, an entry of 0-5 (0 is entryTime and 5 is exitTime) is added in node 3. Upon reaching the load lock, a check is performed to determine whether the amount of wafers in the load lock are equal to the FCN, and it is determined that another wafer can be accommodated according to the FCN rule.

A second wafer (e.g., wafer2) present in slot 1 of the load port starts its cycle. Wafer2 uses heuristics, as described above, to find the next outgoing path. Since the path leading to node 3 has an exitTime of 5 time units (e.g., since it is known that this path is available to wafer2 only after 5 time units), it is determined that the path leading to node 4 is the optimal path since node 4 has an exitTime of 0 time units. Wafer2 travels to node 4 and then travels toward node 6 of the load lock. While wafer2 leaves node 4, an entry of 0-5 (0 is entryTime and 5 is exitTime) is added in node 4. After reaching the load lock, it is determined that the number of wafers in the load lock is equal to the FCN. As a result, the next wafer cycle is not started unless both the wafer1 and wafer2 cycles are completed.

Both the wafers reach the load lock at 10 time units. Both the wafers pump the load lock to vacuum state at time 20 time units (e.g., as a result of the load lock pump and vent time being 10 time units, as described above).

It is then determined that only one outgoing edge from current node 5 exists for wafer1. Thus, an entry of 10-20 is added in node 5, and wafer1 travels to node 9 at time 25 time units. Node 9 has 2 outgoing edges, and according to heuristics, as described above, both are determined to be equally optimal. Thus, wafer1 travels to node 11 at time 30 time units. The entry 20-30 is added in node 9 at 25 time units. Wafer2 similarly travels to node 10 at time 25 time units. At this point, wafer2 has two outgoing paths—one leading to processing module 1 and another leading to processing module 2. Both paths are determined to be equally optimal. However, wafer2 travels to node 12 of processing module 1 since its peer wafer, wafer1, has opted to travel to processing module 1.

Thus, both wafers wafer1 and wafer2 reach processing module 1 at time 30 time units, and are processed in processing module 1 for 10 time units (e.g., processing of both wafers wafer1 and wafer2 is completed at 40 time units). Since processing module 1 is included in the recipe, the recipe step index is incremented to reflect the next recipe step. That is, since wafers wafer1 and wafer2 satisfy the first step of the recipe by traveling to one of processing modules 1 and 2, the recipe step index is incremented to reflect that the next step relating to wafers wafer1 and wafer2 is to travel to the cooler.

After the processing is completed in processing module 1, wafer1 travels toward node 9 and reaches node 9 at time 45 units. Since the next target node belongs to the load lock, it is determined whether the load lock is in its vacuum state at 45 time units. In this exemplary scenario, the load lock is in its vacuum state at 45 time units. As a result, wafer1 reaches node 7 at time 50 time units. Similarly, wafer2 reaches node 10 at 45 time units and then node 8 at time 50 time units, and the entry 40-50 is added in node 10. Both wafers vent load lock at time 60 time units, and entry 50-60 is added in node 7 and node 8.

Wafer1 reaches node 3 at 65 time units and it has two paths: one leading to the destination (e.g., the load port) and other leading to the cooler. Since the cooler is the next recipe step, wafer1 travels to the cooler at time 70 units. Similarly, wafer2 reaches the cooler at 70 time units. Both wafers are processed in the cooler for 5 time units. Thus, the cooling process for both wafers is completed at a total time of 75 time units. Since traveling to the cooler is a recipe step, the recipe index is incremented. In addition, an entry of 70-75 is added to node 15 and node 16. Wafer1 then travels to node 3 at 80 time units, and since all recipe steps have been completed, wafer1 travels back to the load port at 85 time units. An entry of 75-85 is added to node 3. Similarly, wafer2 returns to the destination (e.g., the load port) and an entry of 75-85 is added to node 4, and the first iteration ends.

TABLE 1
Entries in Nodes after Iteration 1

| | | Iteration 1 |
|---|---|---|
| Equipment | Nodes | (Entry Time-Exit Time) |
| Robot 1 | 3, 4 | 0-10, 60-70, 75-85 |
| Load Lock | 5, 6 | 10-20 |
| | 7, 8 | 50-60 |
| Robot 2 | 9, 10 | 20-30, 40-50 |
| Processing Module 1 | 11, 12 | 30-40 |
| Cooler | 15, 16 | 70-75 |

### Iteration 2:

After the processing of wafer1 and wafer2 has been completed, iteration 2 starts. Wafer3 present in the load lock starts its execution. Wafer3 has two outgoing paths: one path leading to node 3 and one path leading to node 4. The entries made by the previous wafers (wafer1 and wafer2) in node 3 and node 4 is checked to determine when the nodes are available. Wafer1 and wafer2 have made three entries: 0-10, 60-70 and 75-85 in node 3 and node 4 respectively, which indicates that nodes 3 and 4 are available from 10-60 time units.

Wafer3 uses heuristics, as described above, to determine the optimal outgoing path, which is the path leading to node 3. Wafer3 starts traveling from node 1 at time 10 units and reaches node 3 at time 15 units. Since the next node is in the load lock, the state that the load lock will be in at time 20 units is checked (since wafer3 will take an additional 5 time units to reach the load lock). The load lock was in the vacuum state at 20 time units, wafer3 vents the load lock at time 30 units, and enters node 5.

Similarly, wafer4 reaches node 6 at 30 time units. Entries of 10-30 are added for both wafers in node 3 and node 4. Wafer3 and wafer4 pump the load lock at time 40 units. Wafer3 attempts to reach the next target, node 9, at time 40 units. However, node 9 has an entry of 40-50. As a result, it is determined that node 9 is not available to receive wafer 3 until 50 time units. Thus, wafer3 waits until 50 time units in node 5. At time 50 units, wafer3 travels toward node 9 and reaches node 9 at 55 time units. At this point, wafer3 has 2 paths: one leading to node 11 and another leading to node 13. According to heuristics, as described above, both the nodes are determined to be optimal. Thus, wafer3 travels to node 11 and reaches node 11 at time 60 units.

Similarly, wafer4 reaches node 12 at time 60 units. Entry 20-50 is added for both wafers to node 5 and node 6, respectively. In addition, entry 50-60 is added for both wafers to node 9 and node 10, respectively. Both wafers are processed in processing module 1 at time 70 units. Entry 60-70 is added for both wafers to node 11 and node 12, respectively. Wafer3 reaches node 9 at time 75 units and tries to enter the load lock. However, the load lock is in an atmospheric state at time 75 units. As a result, wafer3 pumps the load lock and enters node 7 at time 90 units. Similarly, wafer4 enters node 8 at time 90 units. An entry of 70-90 is added to node 9 and node 10, respectively. Both wafers vent the load lock at time 100 units. While leaving the load lock, entry 90-100 is added to node 7 and node 8.

Wafer3 reaches node 3 at time 105 units, and the recipe steps are followed, which takes wafer3 to node 15. Wafer3 reaches node 15 at time 110 units. Similarly, wafer4 reaches node 16 at time 110 units. Both wafers are processed in the cooler until 115 time units, at which point wafer3 travels to node 3. Since the recipe is now completed, wafer3 travels back to the destination (node 1) at time 125 units. In addition, wafer4 travels back to node 1 at time 125 units.

TABLE 2
Entries in Nodes after Iteration 2

| | | Iteration 1 | Iteration 2 |
|---|---|---|---|
| Equipment | Nodes | (Entry Time-Exit Time) | (Entry Time-Exit Time) |
| Robot 1 | 3, 4 | 0-10, 60-70, 75-85 | 10-30, 100-110, 115-125 |
| Load Lock | 5, 6 | 10-20 | 20-50 |
| | 7, 8 | 50-60 | 80-100 |
| Robot 2 | 9, 10 | 20-30, 40-50 | 50-60, 70-90 |
| Processing | 11, 12 | 30-40 | 60-70 |
| Module 1 | | | |
| Cooler | 15, 16 | 70-75 | 110-115 |

### Iteration 3:

After wafer3 and wafer4 return back to the destination, iteration 3 starts. In iteration 3, wafer5 and wafer6 will be processed. Based on the entries made in Table 1 and Table 2, it can be determined that the load lock is not available until time 60 units, and that node 3 in Robot 1 is not busy from time 30-60 units. Thus, wafer5 starts its execution at time 50 units. Wafer5 has two outgoing paths: one leading to node 3 and another leading to node 4. Based on heuristics, as described above, both paths are determined to be optimal. Node 3 is chosen for wafer5, and wafer5 reaches node 3 at time 55 units. Since the next node, node 5, is in the load lock, the load lock is checked to determine whether it is in an atmospheric state at time 60 units (since there is additional transfer time of 5 units). The load lock is in an atmospheric state at time 60 units. As a result, wafer5 travels to node 5 at time 60 units. Since, the FCN is greater than the number of wafers, wafer6 follows the same process and enters node 6 at time 60 units.

Both wafers pump the load lock to the vacuum state at time 70 units. Referring to wafer5, after pumping, it is checked to determine whether this state change in the load lock affects any previous wafers (e.g., it is checked to determine whether the load lock has been determined to be in the atmospheric state after 70 time units for any previous wafers). It can be seen from iteration 2 that it was determined for wafer3 and wafer4 that the load lock was in the atmospheric state at time 80 units, and thus, that the load lock had to be pumped for wafer3 and wafer4. However, since the load lock has already been pumped for wafer5 and wafer6, wafer3 and wafer4 may enter the load lock without pumping. Thus, the cycle of wafer3 and wafer4 may be optimized. Therefore, the correction sub-module 204 takes control and starts a self-correction process for wafer3 and wafer4.

### Iteration 2 Self-Correction:

The cycle of wafer3 and wafer4 is started when Robot 2 picks up both wafers. Wafer3 moves to node 9 at time 75 units. Referring to wafer3, since the next target node (node 7) is in the load lock, it is checked to determine whether the load lock is in the vacuum state at time 80 units. Since the load lock has been pumped for wafer5 and wafer6, it is in the vacuum state at time 80 units. Thus, wafer3 reaches node 7 at time 80 units. Similarly, wafer4 reaches node 8 at time 80 units. Both wafers vent the load lock to the atmospheric state at time 90 units. Similarly, the cycle of both wafers is completed at time 115 units, saving 10 units of time. Resuming Iteration 3:

After self-correction is completed, wafer5 and wafer6 are processed. The next target node for wafer5 is node 9. The current time is 70 units. However, node 9 has an entry of 70-80, which means that node 9 is available only after 80 time units. Thus, a wait time of 10 units is added to the current time for wafer5, wafer5 reaches node 9 at time 95 units, and then reaches node 11 at time 100 units. Similarly, wafer6 reaches node 12 at time 100 units. Both wafers are processed in the processing module for 10 time units until time 110 units.

TABLE 3
Entries in Nodes after Iteration 3

| | | Iteration 1 | | |
|---|---|---|---|---|
| | | (Entry | Iteration 2 | Iteration 3 |
| | | Time-Exit | (Entry Time - Exit | (Entry Time - |
| Equipment | Nodes | Time) | Time) | Exit Time) |
| Robot 1 | 3, 4 | 0-10, | 10-30, | 50-60, 145-155 |
| | | 60-70, | [symbol] (90-100), | |
| | | 75-85 | [symbol] (105-115) | |
| Load Lock | 5, 6 | 10-20 | 20-50 | 60-80 |
| | 7, 8 | 50-60 | [symbol] (80-90) | 110-130 |
| Robot 2 | 9, 10 | 20-30, | 50-60, [symbol] | 80-90, 100-120 |
| | | 40-50 | (70-80) | |
| Processing | 11, 12 | 30-40 | 60-70 | 90-100 |
| Module 1 | | | | |
| Cooler | 15, 16 | 70-75 | [symbol] (100-105) | 140-145 |
| Load Port | 1 | 75 | [symbol] (115) | 155 |

In Table 3, strikethrough indicates the values before self-correction, and the values in parentheses are the corrected values.

The exemplary embodiments disclosed herein may be implemented through at least one software program running on at least one hardware device and performing network management functions to control the network elements. The network elements shown in FIG. 2 include blocks which can be, for example, at least one of a hardware device, a software device, or a combination of hardware device and software modules.

The exemplary embodiments disclosed herein specify a system and method for throughput determination of a semiconductor manufacturing tool. Exemplary embodiments allow for the determination of the throughput of a semiconductor manufacturing tool. Exemplary embodiments may be realized via, for example, a system that includes a memory storing a computer program, and a processor configured to execute the computer program, in which the computer program performs the operations described herein. For example, referring to FIGS. 1 and 2, at least one of the modules/sub-modules may correspond to a processor that executes a computer program stored in a memory (e.g., the memory sub-module 206), to perform the operations described herein. In addition, exemplary embodiments may be realized via, for example, a computer program product that includes a computer readable storage medium having program instructions embodied therein, which are executable by a processor, to cause the processor to perform the operations described herein. The program instructions may run on various computing devices such as, for example, a server or mobile device, or any suitable programmable device. The methods described herein may be implemented using, for example, a software program written in, e.g., Very high Speed Integrated Circuit Hardware Description Language (VHDL), another programming language, etc., or implemented by one or more VHDL or several software modules being executed on at least one hardware device. Exemplary embodiments may be embodied as, for example, a firmware chip, a programmable chip, etc., which may be inserted into a system and which may directly provide its output to equipment that creates semiconductor manufacturing tools, as described above. The hardware device may include a combination of components such as, for example, at least one field-programmable gate array (FPGA), at least one application-specific integrated circuit (ASIC), at least one microprocessor, at least one memory with software modules located therein, etc. The exemplary embodiments described herein may be implemented using, for example, only hardware or using a combination of hardware and software. Exemplary embodiments may be implemented on different hardware devices using, for example, a plurality of CPUs.

Exemplary embodiments of the inventive concept provide a system that uses throughput models to determine the throughput of various types of semiconductor manufacturing tools having various components and configurations, thus, providing a system and method having high interoperability (e.g., as opposed to a system that uses a throughput model to determine the throughput of only one specific type of semiconductor manufacturing tool).

While the present inventive concept has been particularly shown and described with reference to the exemplary embodiments thereof, it will be understood by those of ordinary skill in the art that various changes in form and detail may be made therein without departing from the spirit and scope of the present inventive concept as defined by the following claims.

What is claimed is:

1. A method for measuring a throughput of a semiconductor manufacturing tool, comprising:
receiving a layout of the semiconductor manufacturing tool as an input;
calculating a full capacity number (FCN) based on a number of a plurality of wafer-receiving slots disposed in at least one component of the semiconductor manufacturing tool;
determining a number of a plurality of wafers to be processed by the semiconductor manufacturing tool based on the FCN;
determining a path for the wafers to enter stages of the semiconductor manufacturing tool based on at least one parameter;
determining a time for one of the wafers to enter at least one of the wafer-receiving slots based on a feedback value, wherein the feedback value represents a time at which the at least one wafer-receiving slot is available to receive the one of the wafers; and
determining a process completion time based on the determined time for the one of the wafers to enter the at least one of the wafer-receiving slots, wherein the process completion time indicates a total time taken by the semiconductor manufacturing tool to process and output the plurality of wafers.

2. The method of claim 1, wherein the at least one component is at least one processing chamber.

3. The method of claim 1, wherein the at least one parameter includes a shortest path to a destination, a transfer time between components of the semiconductor manufacturing tool, a waiting time of at least one processing chamber in the semiconductor manufacturing tool, or a processing time of the at least one processing chamber.

4. The method of claim 1, wherein determining the path for the wafers to enter the stages of the semiconductor manufacturing tool is based on at least two parameters from among a shortest path to a destination, a transfer time between components of the semiconductor manufacturing tool, a waiting time of at least one processing chamber in the semiconductor manufacturing tool, and a processing time of the at least one processing chamber.

5. The method of claim 1, wherein determining the time for the one of the wafers to enter the at least one wafer-receiving slot comprises:
determining a nodeTime corresponding to a previous wafer that has previously entered the at least one wafer-receiving slot, wherein the nodeTime indicates a time at which the at least one wafer-receiving slot is available for the wafer.

6. The method of claim 5, further comprising:
adding a wait time to the time at which the at least one wafer-receiving slot is available.

7. The method of claim 1, wherein the process completion time is determined based on at least one of a nodeTime corresponding to each of the plurality of wafer-receiving slots, and a processing capability of at least one processing chamber in the semiconductor manufacturing tool.

8. A system for measuring a throughput of a semiconductor manufacturing tool, comprising:
a memory storing a computer program; and
a processor configured to execute the computer program, wherein the computer program is configured to:
receive a layout of the semiconductor manufacturing tool as an input;
calculate a full capacity number (FCN) based on a number of a plurality of wafer-receiving slots disposed in at least one component of the semiconductor manufacturing tool;
determine a number of a plurality of wafers to be processed by the semiconductor manufacturing tool based on the FCN;
determine a path for the wafers to enter stages of the semiconductor manufacturing tool based on at least one parameter;
determine a time for one of the wafers to enter at least one of the wafer-receiving slots based on a feedback value, wherein the feedback value represents a time at which the at least one wafer-receiving slot is available to receive the one of the wafers; and
determine a process completion time based on the determined time for the one of the wafers to enter the at least one of the wafer-receiving slots, wherein the process completion time indicates a total time taken by the semiconductor manufacturing tool to process and output the plurality of wafers.

9. The system of claim 8, wherein the at least one component is at least one processing chamber.

10. The system of claim 8, wherein the at least one parameter includes a shortest path to a destination, a transfer time between components of the semiconductor manufacturing tool, a waiting time of at least one processing chamber in the semiconductor manufacturing tool, or a processing time of the at least one processing chamber.

11. The system of claim 8, wherein determining the path for the wafers to enter the stages of the semiconductor manufacturing tool is based on at least two parameters from among a shortest path to a destination, a transfer time between components of the semiconductor manufacturing tool, a waiting time of at least one processing chamber in the semiconductor manufacturing tool, and a processing time of the at least one processing chamber.

12. The system of claim 8, wherein determining the time for the one of the wafers to enter the at least one wafer-receiving slot comprises:
determining a nodeTime corresponding to a previous wafer that has previously entered the at least one wafer-receiving slot, wherein the nodeTime indicates a time at which the at least one wafer-receiving slot is available for the wafer.

13. The system of claim 12, wherein determining the time for the one of the wafers to enter the at least one wafer-receiving slot further comprises:
adding a wait time to the time at which the at least one wafer-receiving slot is available.

14. The system of claim 8, wherein the process completion time is determined based on at least one of a nodeTime corresponding to each of the plurality of wafer-receiving slots, and a processing capability of at least one processing chamber in the semiconductor manufacturing tool.

15. A computer program product for measuring a throughput of a semiconductor manufacturing tool, the computer program product comprising a computer readable storage medium having program instructions embodied therewith, the program instructions executable by a processor to cause the processor to:
receive a layout of the semiconductor manufacturing tool as an input;
calculate a full capacity number (FCN) based on a number of a plurality of wafer-receiving slots disposed in at least one component of the semiconductor manufacturing tool;
determine a number of a plurality of wafers to be processed by the semiconductor manufacturing tool based on the FCN;
determine a path for the wafers to enter stages of the semiconductor manufacturing tool based on at least one parameter;
determine a time for one of the wafers to enter at least one of the wafer-receiving slots based on a feedback value, wherein the feedback value represents a time at which the at least one wafer-receiving slot is available to receive the one of the wafers; and
determine a process completion time based on the determined time for the one of the wafers to enter the at least one of the wafer-receiving slots, wherein the process completion time indicates a total time taken by the semiconductor manufacturing tool to process and output the plurality of wafers.

16. The computer program product of claim 15, wherein the at least one component is at least one processing chamber.

17. The computer program product of claim 15, wherein the at least one parameter includes a shortest path to a destination, a transfer time between components of the semiconductor manufacturing tool, a waiting time of at least one processing chamber in the semiconductor manufacturing tool, or a processing time of the at least one processing chamber.

18. The computer program product of claim 15, wherein determining the path for the wafers to enter the stages of the semiconductor manufacturing tool is based on at least two parameters from among a shortest path to a destination, a transfer time between components of the semiconductor manufacturing tool, a waiting time of at least one processing chamber in the semiconductor manufacturing tool, and a processing time of the at least one processing chamber.

19. The computer program product of claim 15, wherein determining the time for the one of the wafers to enter the at least one wafer-receiving slot comprises:
determining a nodeTime corresponding to a previous wafer that has previously entered the at least one wafer-receiving slot, wherein the nodeTime indicates a time at which the at least one wafer-receiving slot is available for the wafer.

20. The computer program product of claim 19, wherein determining the time for the one of the wafers to enter the at least one wafer-receiving slot further comprises:
adding a wait time to the time at which the at least one wafer-receiving slot is available.
